(19) United States
(12) Patent Application Publication
(10) Pub. No.: US 2003/0201972 A1
(43) Pub. Date: Oct. 30, 2003

(54) Terminal apparatus, and character input method for such terminal apparatus

(75) Inventor: Hiroshi Usuda, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Corporation, Tokyo (JP)

(21) Appl. No.: 10/420,468

(22) Filed: Apr. 22, 2003

(30) Foreign Application Priority Data
Apr. 25, 2002 (JP) P2002-124106

(51) Int. Cl. G09G 5/00

(52) U.S. Cl. 345/156

(57) ABSTRACT

A terminal apparatus is configured to carry out a scroll operation of a picture image by detecting a movement of the apparatus body, and to display on a display screen a virtual keyboard having a size larger than the size of the display screen. The virtual keyboard includes a plurality of key areas dividing the keyboard in the vertical and horizontal directions. A key area at a predetermined position on the display screen is highlighted so as to be identified as a key area capable of carrying out a key input, and a highlighted key area is moved by moving the virtual keyboard using the scroll operation. Then, when a desired key area is highlighted, a corresponding key code is input by depressing an OK button.

### CROSS REFERENCE TO RELATED APPLICATIONS

This application claims priority from Japanese Application No. P2002-124106, filed on Apr. 25, 2002, the disclosure of which is hereby incorporated by reference herein.

### BACKGROUND OF THE INVENTION

The present invention relates to a terminal apparatus that is able to carry out a scroll display of a display screen, and a character input method thereof.

In a portable terminal or a cellular phone, the amount of information able to be displayed on the display screen of the apparatus is generally poor and small. Thus, when displaying on the display screen a picture image that is larger than the display screen, a so-called scroll display function is used. Although this scroll display function is widely employed in personal computers and the like, it is not practical to apply similar operation means to portable type terminal apparatus, and accordingly, in portable type terminal apparatus, almost all functions in addition to the scroll display are often made available by the operation of buttons.

As a method that is able to improve operability of the scroll display in a portable type terminal apparatus, there is a Japanese Patent Laid-Open Patent Application No. 2002-7027, for example. In this Laid-Open Patent Application, there is disclosed a technology wherein a movement of the apparatus body in backward, forward and left and right directions is detected by an acceleration sensor or the like, for example, and based on the detected result, a picture image in the display screen is simultaneously made to scroll in the moving direction of the apparatus body. According to such technology, troublesome button operations are no longer needed to effect a scroll display as described above, and it is therefore possible to carry out a scroll display in coincidence with human intuition.

In a portable type terminal apparatus such as a portable terminal or a cellular phone, the portability is given a priority as previously described, therefore, not only the display screen but also the size of an operation section is severely limited. Accordingly, it is extremely difficult to provide a standard keyboard as normally used in a personal computer. Then, when realizing a terminal apparatus while supporting character input, a system is employed for realizing the function of a keyboard, such as a so-called virtual keyboard or software keyboard.

However, the size of a keyboard displayed on the display screen is naturally limited by the size of the display screen of the terminal apparatus, and therefore there is a problem where the visual selectivity of keys is poor, and the number of keys is limited because the size of each key is too small.

In addition, a cursor key, a touch panel sensor or a tablet become necessary as means for selecting keys, however, when a cursor key is provided, the size of the apparatus body increases, and when a touch panel sensor or a tablet is employed, the price increases.

### SUMMARY OF THE INVENTION

In consideration of the above mentioned situation, one aspect of the present invention is to provide a terminal apparatus and a character input method, wherein the character input operation is able to be carried out comfortably, even though the size of the display screen is rather small.

In order to achieve the above aspect, a terminal apparatus of the present invention includes a display unit operable to display a picture image, the picture image including a keyboard having a plurality of key areas each of which is assigned a function for a character input; a display screen for displaying at least a part of the picture image; scroll means for moving a position of the picture image relative to the display screen so that one of the key areas is displayed at a predetermined position on the display screen; and an input unit operable to execute a function corresponding to the one of the key areas when the one of the key areas is displayed at the predetermined position on the display screen.

For example, functions for use in character input include functions to input all kinds of characters such as a numeral, a Romaji, and a space, and furthermore include functions of various controls for use in character input such as shifting of an upper-case/lower-case mode, and a Kana/Kanji conversion. The predetermined position on the display screen is a position enabling key input in the display screen, and the key area in this position is an input object. This position is preferably set to be identified in the display screen. A user controls the scroll means and selects the one of the key areas displayed at the predetermined position on the display screen.

According to the present invention, a character input can be carried out by moving a keyboard displayed on a display screen as a picture image and by selecting any key area to be input. Therefore, a mechanical structure for selecting keys is not necessary, and miniaturization/low price can be obtained.

In addition, according to the present invention, the size of the picture image can be larger than the size of the display screen. Therefore, as a result, the size of an individual key area can be selected with a high degree of freedom, and accordingly, the visual selectivity of keys is improved. Furthermore, as the number of keys has no limitation, an effective character input operation becomes possible. For example, the size of the picture image may be larger than the size of the display screen in at least one axis direction of the display screen.

Furthermore, the terminal apparatus of this invention may include detecting means for detecting movement of the terminal apparatus, and the scroll means may move the position of the picture image relative to the display screen based on the movement of the terminal apparatus. As described above, by using such scroll means, a suitable scroll operation is enabled in a human perception, and the operability upon selecting the key while moving the keyboard picture image is improved. The scroll means may move the picture image in increments based on the size of the key areas. According to this, the operability upon selecting the key is improved, and the character input can be accomplished effectively.

Furthermore, the display screen may include a first display area operable to display a scrolling image, and a second display area not operable to display a scrolling image; and characters input by the input unit may be displayed in the second display area. As the user can confirm the input characters, the operability of the key input is improved.

A method of inputting characters for display on a display screen in accordance with another aspect of the present invention includes displaying a picture image on the display screen, the picture image including a keyboard having a plurality of key areas each of which is assigned a function for a character input. The position of the picture image is moved relative to the display screen so that one of the key areas is displayed at a predetermined position on the display screen; and a function is executed corresponding to the one of the key areas when the one of the key areas is displayed at the predetermined position on the display screen.

### BRIEF DESCRIPTION OF THE DRAWINGS

FIG. 1 is a perspective view schematically illustrating the appearance of a terminal apparatus in accordance with one embodiment of the present invention;

FIG. 2 is a block diagram showing the hardware configuration of the terminal apparatus of FIG. 1;

FIG. 3 is a block diagram showing a program of the terminal apparatus and a part of a configuration of data;

FIG. 4 is a diagram for explaining a scroll display function of the terminal apparatus;

FIG. 5 is a diagram showing a form of a virtual keyboard on a display screen of the terminal apparatus;

FIG. 6 is a diagram showing one example of an area/input code conversion table;

FIG. 7 is a diagram showing correspondence of a key area and a key arrangement of the virtual keyboard;

FIG. 8 is a flow chart showing operation of the terminal apparatus;

FIG. 9 is a diagram showing a condition in which a photo image is displayed on the display screen of the terminal apparatus;

FIG. 10 is a diagram showing a condition in which a menu image is displayed on the display screen of the terminal apparatus;

FIG. 11 is a diagram showing a condition just after activation of the virtual keyboard;

FIG. 12 is a flow chart showing a character input procedure of the virtual keyboard;

FIG. 13 is a diagram showing a condition of a character input with the virtual keyboard displayed on the display screen of the terminal apparatus;

FIG. 14 is a diagram showing a condition of another character input with the virtual keyboard displayed on the display screen of the terminal apparatus; and

FIG. 15 is a diagram showing a condition where characters are pasted to a photo image.

### DETAILED DESCRIPTION

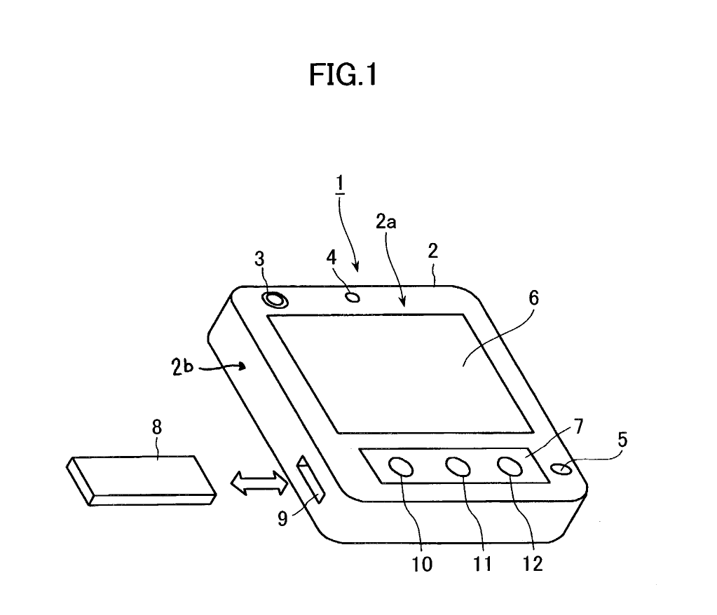

A detailed description of the preferred embodiment of the present invention will now be described in detail with reference to the accompanying drawings. FIG. 1 is a perspective view schematically illustrating the appearance of a terminal apparatus 1 in accordance with one embodiment of the present invention.

As shown in FIG. 1, the terminal apparatus 1 has a housing 2 having a size that a user is able to carry with a single hand, for example. At a front face 2a of the housing 2, a camera 3, a microphone 4, a speaker 5, a display unit 6, and an operation area 7 are respectively provided. Further, at a side face 2b of the housing 2, a connecting unit 9 is provided for freely connecting/disconnecting a stick-shaped storage medium 8, for example. The camera 3 is configured with a CCD camera, for example, and the display unit 6 is configured with a color liquid crystal display apparatus, for example. An OK button 10, an Undo button 11, and a camera capture button 12 are provided in the operation area 7.

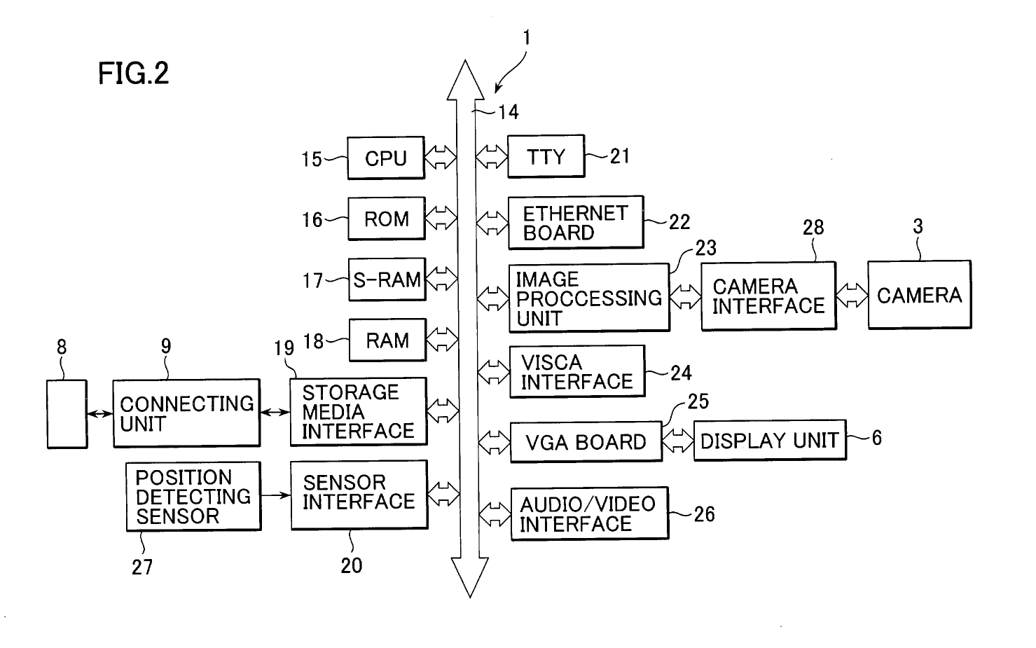

FIG.2 is a block diagram showing the hardware configuration of the terminal apparatus 1. As shown in FIG. 2, the terminal apparatus 1 includes a main bus 14 to which are connected a CPU 15, a ROM 16, an S-RAM (Static RAM) 17, a RAM 18, a storage media interface 19, a sensor interface 20, and other types of interfaces, such as a TTY (Tele-Typewriter) 21, an Ethernet board (Registered Trademark) 22, an image processing unit 23, a Visca interface 24, a VGA board 25, and an audio/video interface 26.

The CPU 15 controls the overall terminal apparatus 1. Various programs necessary for operating the terminal apparatus 1 are stored in the ROM 16. User information such as picture images, sound data, and document data are stored in the S-RAM 17, and the RAM 18 is used as a work space for processing in the terminal apparatus 1. The connecting unit 9 is connected to the storage media interface 19, so that data can be communicated to/from a storage media 8 to be loaded in the connecting unit 9.

A position detecting sensor 27 is connected to the sensor interface 20. As the position detecting sensor 27, an acceleration sensor and/or an angular velocity sensor can be used, for example. An acceleration sensor is an element that detects the acceleration of the terminal apparatus 1 in the biaxial or triaxial direction when, for example, the user moves the terminal apparatus 1 by hand through space. The acceleration sensor may be used to detect the vertical and horizontal components of the acceleration that is applied to the terminal apparatus 1, and calculates a velocity component and a displacement component by conducting a time integration operation. This calculation result may be used to scroll picture images as described later.

The TTY (Tele-Typewriter) 21 is connected to the buttons 10, 11, and 12 in the above-mentioned operation area 7.

The Ethernet board 22 allows the terminal apparatus 1 to connect with an Ethernet. The terminal apparatus 1 is, for example, connected to a host device by way of the Ethernet, and may be connected to the Internet by way of the host device and Ethernet. Further, it may be possible for the terminal apparatus 1 to be connected directly online to the Internet without the host device, and to be connected to a server apparatus which distributes content.

A camera interface 28 is connected to the image processing unit 23, and the above-mentioned CCD camera 3 is connected to the camera interface 28. It is possible to transfer picture images captured by the CCD camera 3 to the terminal apparatus 1, and to display them on the display unit 6.

External personal computers or the like are connected to the Visca interface 24, and it is possible to carry out the various controls of the terminal apparatus 1 by way of this interface. A liquid crystal display apparatus serving as the above-mentioned display unit 6 is connected to the VGA board 25.

Audio-visual devices may be connected to the audio/video interface 26. It is possible to input signals from the audio-visual devices into the terminal apparatus 1 through this audio/video interface 26, and it is also possible to output audio signals and video signals from the terminal apparatus 1 to the audio-visual devices.

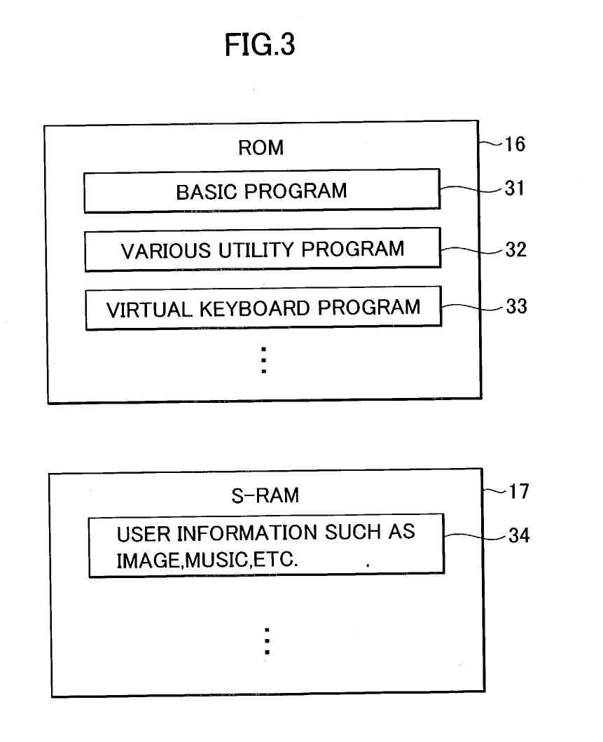

FIG. 3 shows various programs and a part of the configuration of data stored in the ROM 16 and the S-RAM 17. The ROM 16 includes a basic program 31 necessary for operating the terminal apparatus 1, various utility programs, such as for browsing web contents, transmitting/receiving of E-mail, drawing graphics, reproducing sound, editing documents, and other utility functions, and a virtual keyboard program 33 for a key code input function by a virtual keyboard which will be described later. In this case, the program 33 for the key code input function by the virtual keyboard may be included in the basic program 31.

In the S-RAM 17 are stored user information 34, such as picture images, sound, documents, and the like, and various setting data. In this case, the user information 34 and the setting data may be stored in a storage medium 8 which may be detached from the terminal apparatus 1.

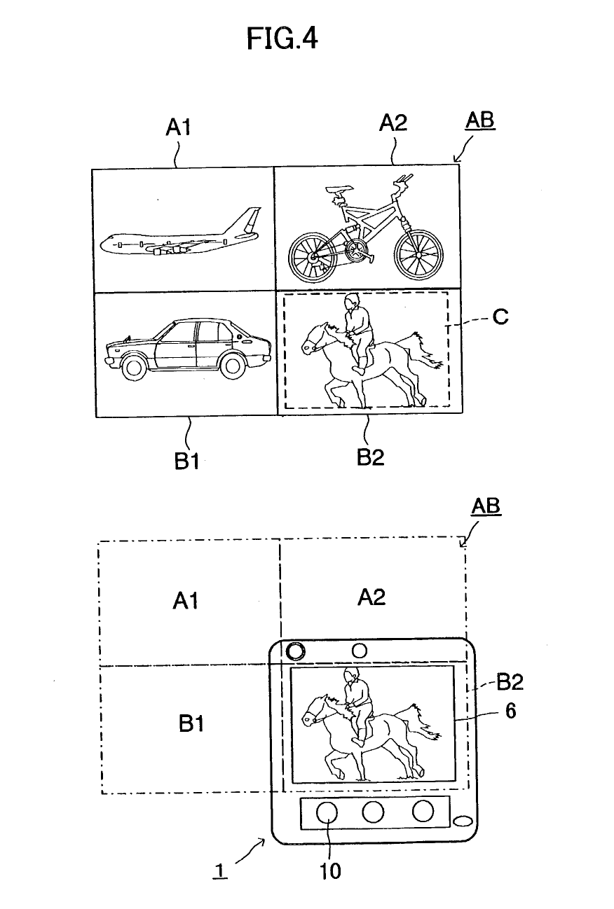

The terminal apparatus 1 is equipped with a scroll display function. This scroll display function is realized by hardware or software, or both. The scroll display function of the terminal apparatus 1 is described with reference to FIG. 4. In the figure, a reference AB is a whole picture image, and this whole picture image AB includes partial picture images A1, A2, B1, and B2 obtained, for example, by dividing the whole picture image AB in the horizontal and vertical directions into four areas. The number of partial picture images that form the whole picture image AB is variable. An area C surrounded by a dashed line in the figure shows the area actually displayed on the display screen from among the whole picture image AB. That is, the whole picture image AB is larger than the actual display screen, and only a part of the whole picture image AB can be displayed on the display screen.

When the terminal apparatus 1 is moved in the right direction, the movement of the terminal apparatus 1 is detected by the position detecting sensor 27, thereby causing the picture image AB to scroll in the left direction relative to the area C of the display screen. On the contrary, when the terminal apparatus 1 is moved in the left direction, the movement of the terminal apparatus 1 is detected by the position detecting sensor 27, and the picture image AB is scrolled in the right direction relative to the area C of the display screen. Similarly, when the terminal apparatus 1 is moved in an upward direction or downward direction, the movement of the terminal apparatus 1 is also detected by the position detecting sensor 27, and the picture image AB is scrolled in the downward direction or the upward direction.

As thus described, by moving the terminal apparatus 1 in the right, left, upward and downward directions, a user can eventually see the whole of the picture image AB. And using such operation, a user is able to display a desired partial picture in the area C displayed in the display screen. By then pushing the OK button 10, the partial picture can be selected.

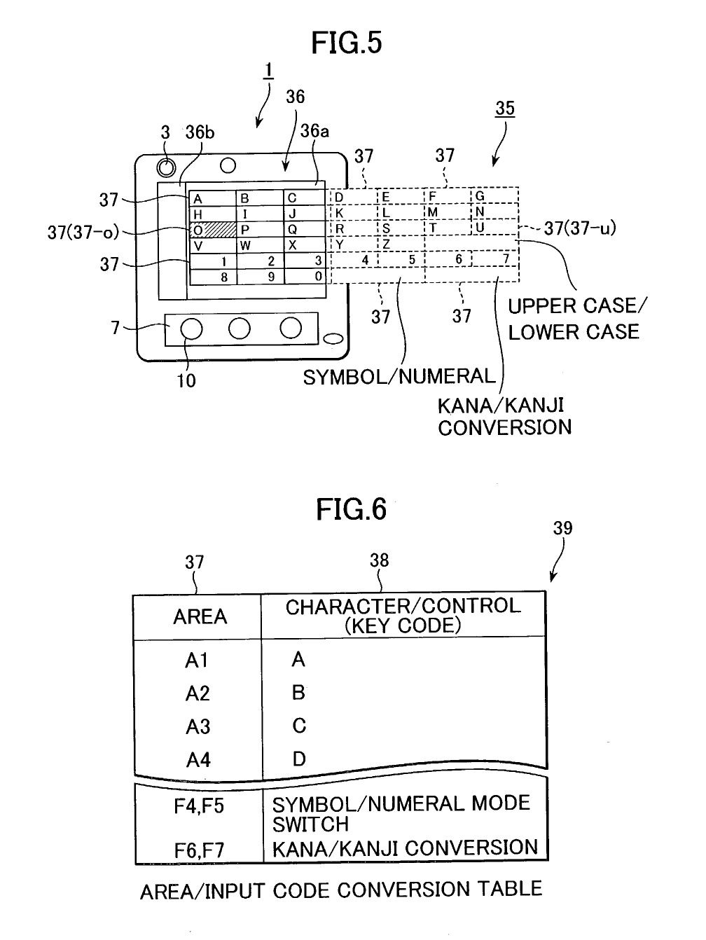

Next, a virtual keyboard for a key code input in cooperation with such scroll display function is explained. A form of a virtual keyboard 35 on the display screen 36 is shown in FIG. 5.

The virtual keyboard 35 is displayed as a picture image on the display screen 36. The picture image of this virtual keyboard 35 consists of plural key areas 37 extending in rows and columns. The kinds of keys include control keys such as, for example, an upper-case/lower-case mode shifting key, a code/numeral mode shifting key, and a Kana/Kanji conversion key other than letter keys to input characters such as letters and numerals. Of course, keys for directly inputting a Kana character, a space key, and the keys which are aligned in a normal keyboard array may also be provided. In addition, a code/numeral mode shifting key means a key changing between a code input mode and a numeral input mode. FIG. 5 shows a numeral input mode, but when the code input mode is selected, the number on the key is changed to a code on the display.

In addition, in this example, the virtual keyboard 35 has a larger size than the display screen 36. Accordingly, the portion of the virtual keyboard 35 depicted in dotted lines is not actually displayed, and the entirety of the virtual keyboard 35 appears on the display screen 36 by means of the scroll operation. Of course, this is just one example, and it is possible for the entirety of the virtual keyboard 35 to be displayed on the display screen 36 simultaneously.

In FIG. 5, the key area 37 of “O” (37-O) of the virtual keyboard 35 is highlighted so that it can be recognized at a glance relative to the other keys. The highlighted display area is not limited to the key area 37 of “O” (37-O), and the highlighted area means an area where the input of a character code or a control code is now available. In other words, in the character input mode, the highlighted display is locked to a predetermined area of the display screen 36, the virtual keyboard 35 is scrolled in the top, bottom, right, and left directions by means of the scroll operation, and the key area 37 displayed in a highlighted condition is changed by changing the position of the virtual keyboard 35 relative to the display screen 36. To input the code corresponding to the highlighted key area 37, the OK button 10 of the operation area 7 only needs to be pushed.

In addition, in the character input mode, the display screen 36 is divided into a scroll display area 36a where the virtual keyboard 35 is able to be displayed and scrolled, and a non-scroll display area 36b where characters and the like input through the virtual keyboard 35 are displayed.

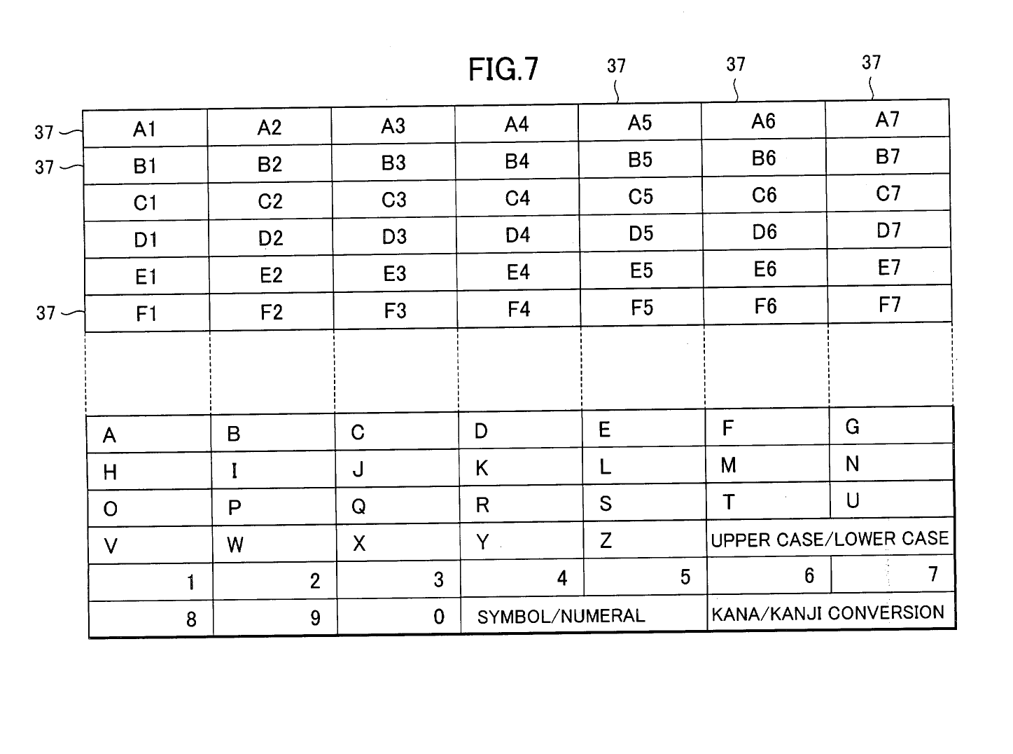

One example of an area/input code conversion table 39 used in order to take in a key code input through the virtual keyboard 35 is shown in FIG. 6. In this area/input code conversion table 39, the area 37 includes the individual key areas 37 of the virtual keyboard 35 as shown in FIG. 7. Character codes and control codes 38 that are taken in as the input are registered in relation with each of the key areas 37. In addition, a user can set his or her favorite key arrangement by providing a function of editing this area/input code conversion table 39.

Next, a description is made of the operation of this terminal apparatus 1. As an example of the operation to be described, a case is explained where a date and a comment are pasted on a photo image which a user takes with the camera 3 of the terminal apparatus 1.

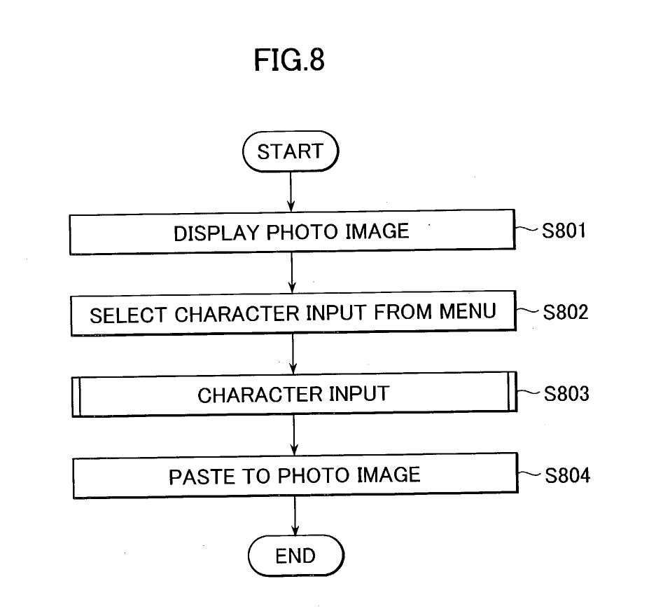

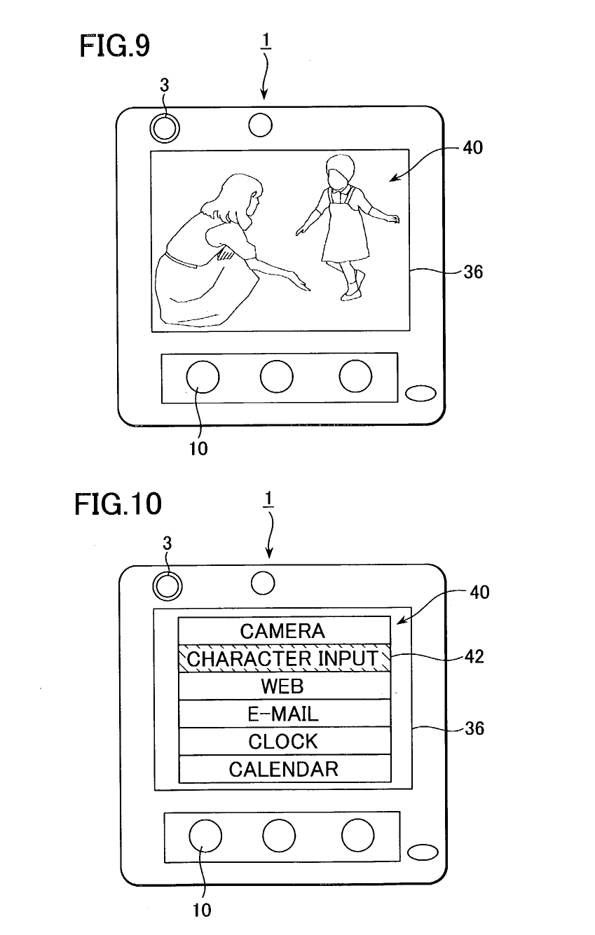

This operational example of the procedure is depicted in FIG. 8. At first, as shown in FIG. 9, a photo image 40 is displayed on the display screen 36 in step 801. Then, a predetermined operation commands the terminal apparatus 1 to edit the photo image 40. Thereby, as shown in FIG. 10, a menu screen 41 is displayed. The highlighting indication is moved to an item 42 of character input by means of the scroll operation on this menu screen 41, and the character input function is turned on in step 802 by selecting with the OK button 10.

In addition, in an example of this menu screen 41, function items that are not able to be displayed on the display screen 36 are aligned below. If these concealed items are wanted to be displayed, the menu screen 41 is scrolled downward by moving the terminal apparatus 1 downward.

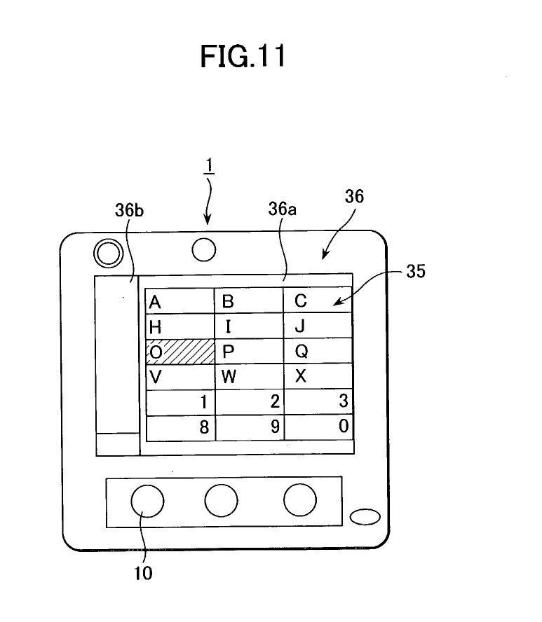

FIG. 11 shows the state in which the virtual keyboard 35 is activated by selecting the character input function. The display screen 36 is divided into the scroll display area 36a and the non-scroll display area 36b when the character input function is selected, and a part of the virtual keyboard 35 is displayed on the scroll display area 36a. In this example, just after the activation of the virtual keyboard 35, the key area 37 of “O” (37-O) is highlighted.

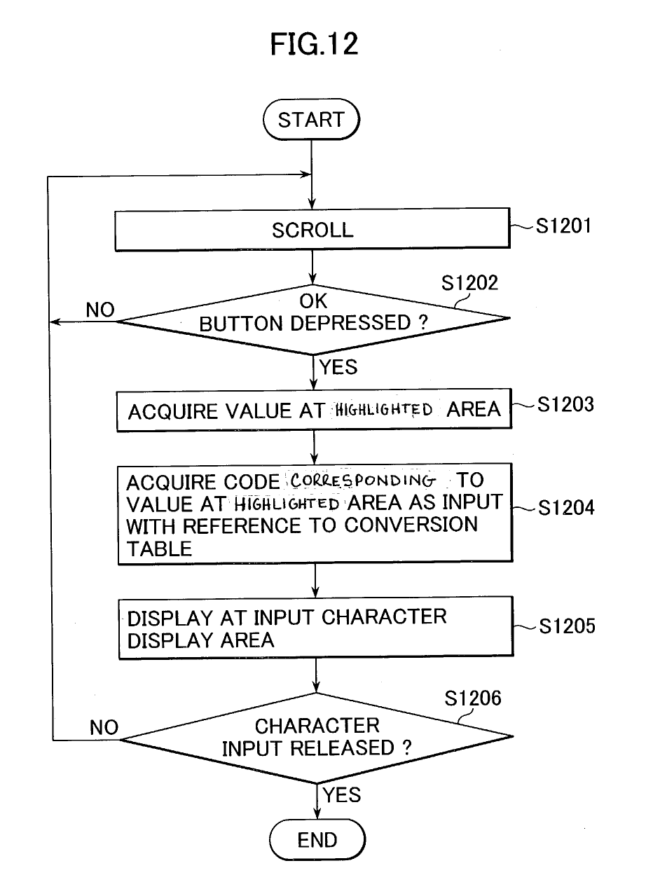

The input of characters is done using the virtual keyboard 35 at step 803 as follows. A procedure for the character input using this virtual keyboard 35 is shown in FIG. 12.

The highlighted area is moved by the scroll operation in the key area 37 to the character which is to be input in step 1201. When the highlight area is moved to the key area 37 of the character that is to be input, then the OK button 10 is pushed in step 1202. Thereby, the virtual keyboard program 33 takes in the value of the key area 37 displayed at the highlighted area, and further, a key code corresponding to the value is read out from the area/input code conversion table 39 in FIG. 6 and taken in as input in step 1204. Furthermore, in step 1205, the virtual keyboard program 33 displays the character in the non-scroll display area 36b if the key code taken in is a character.

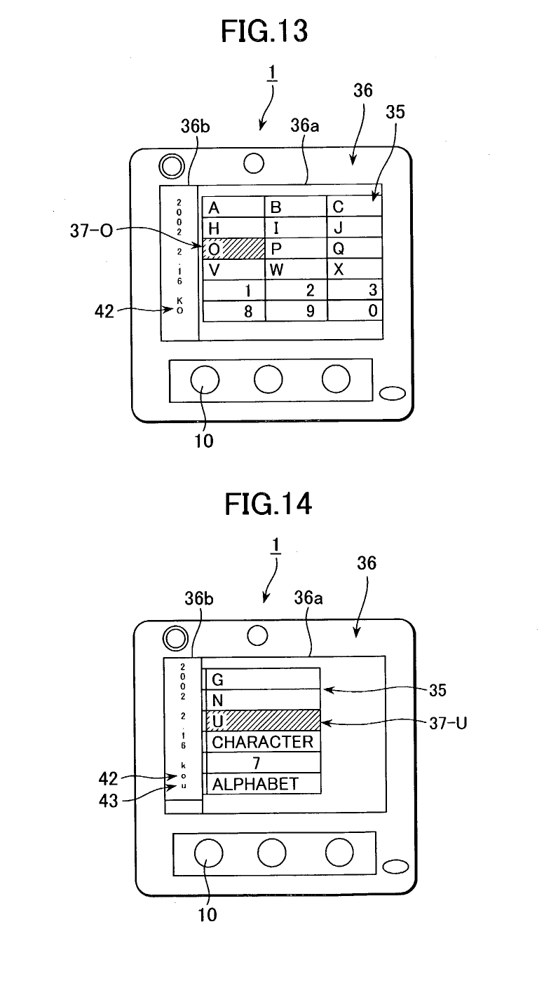

An example of this character input is shown in FIG. 13 and FIG. 14. FIG. 13 shows the condition in which the character “O” of the alphabet is input. When depressing the OK button 10 while highlighting the input key area 37 of “O” (37-O), the character 42 of “O” is added to the end of the character string just input in the non-scroll display area 36b. Following this, as shown in FIG. 14, the highlighted display is moved to the key area 37 of “U” (37-U) by the scroll operation, and by depressing the OK button 10, the character 43 of “U” is added to the end of the character string in the non-scroll display area 36b.

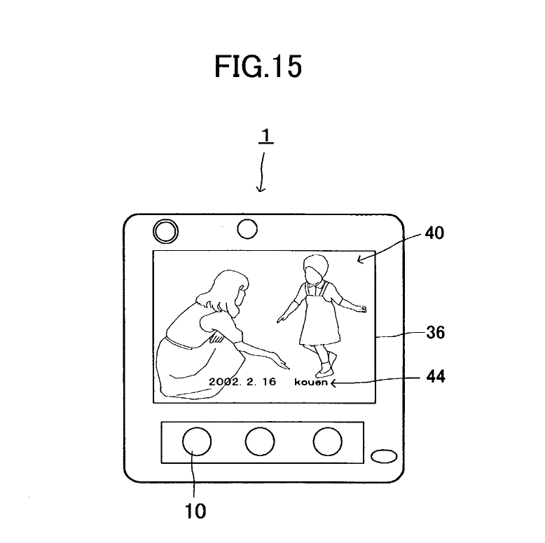

If the character input for the object is completed, the character input function is turned “Off” by the operation of a predetermined button and the like in step 1206. Then, as shown in FIG. 15, the character string 44 input into the non-scroll display area 36b is pasted on the photo image 40 by the operation in step 804 of FIG. 8.

The character input function by the virtual keyboard 35 is not limited to the case where characters are pasted on a photo image, but it is possible to combine it with various utility functions such as the composition of documents, the creation of E-mail text, and the like. In addition, in the character input function of the virtual keyboard 35, it is possible to input Kana by inputting Romaji, and the Kana may be converted into Kanji characters by means of a Kana/Kanji conversion key.

In addition, in the case of character input using the virtual keyboard 35, the virtual keyboard 35 moves intermittently by a unit of the key area 37 depending on the movement of the terminal apparatus 1. Thereby, the operability of the key selection by a user is improved, and the character input can be performed more effectively. Of course, it is possible to continuously move the virtual keyboard 35 depending on the movement of the terminal apparatus 1.

As discussed above, according to the terminal apparatus 1, it is possible to carry out the character input by selecting a desired key area 37 while scrolling the virtual keyboard 35 displayed on the display screen 36 by the movement of the terminal apparatus 1. Therefore, a mechanical structure for selecting keys is not necessary, and miniaturization/low price can be planned.

In addition, the size of the keyboard is not restricted by the size of the display screen, but can be larger than the display screen. Therefore, as a result, the size of an individual key area can be decided with a high degree of freedom, and accordingly, the visual selectivity of keys is improved. Furthermore, as the number of keys has no limitation, an effective character input operation becomes possible.

The present invention is not limited to the above-mentioned embodiment. For example, the virtual keyboard may be sized so that the entire keyboard is displayed on the display screen. In this case, the visibility of the individual keys is lowered, but it is possible to select a key by scrolling the virtual keyboard depending on the terminal apparatus, so that the miniaturization of the terminal apparatus and a low price can be planned.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A terminal apparatus, comprising:
a display unit operable to display a picture image, said picture image including a keyboard having a plurality of key areas each of which is assigned a function for a character input;
a display screen for displaying at least a part of said picture image;
scroll means for moving a position of said picture image relative to said display screen so that one of said key areas is displayed at a predetermined position on said display screen; and
an input unit operable to execute a function corresponding to said one of said key areas when said one of said key areas is displayed at said predetermined position on said display screen.

2. The terminal apparatus as claimed in claim 1, further comprising:
detecting means for detecting movement of said terminal apparatus, whereby said scroll means moves said position of said picture image relative to said display screen based on said movement of said terminal apparatus.

3. The terminal apparatus as claimed in claim 1, wherein
said display screen has a predetermined size in at least one axis direction of said display screen, and said picture image has a size in said at least one axis direction which is larger than said predetermined size.

4. The terminal apparatus as claimed in claim 1, wherein
said scroll means moves said picture image in increments based on a size of said key areas.

5. The terminal apparatus as claimed in claim 1, wherein
said display screen includes a first display area operable to display a scrolling image, and a second display area not operable to display a scrolling image; and
characters input by said input unit are displayed in said second display area.

6. A method of inputting characters for display on a display screen, comprising:
displaying a picture image on the display screen, the picture image including a keyboard having a plurality of key areas each of which is assigned a function for a character input;
moving a position of the picture image relative to the display screen so that one of the key areas is displayed at a predetermined position on the display screen; and
executing a function corresponding to the one of the key areas when the one of the key areas is displayed at the predetermined position on the display screen.

7. The character input method as claimed in claim 6, further comprising:
detecting movement of the terminal apparatus;
wherein the moving step includes moving the position of the picture image relative to the display screen based on the movement of the terminal apparatus.

8. The character input method as claimed in claim 6, wherein
the display screen has a predetermined size in at least one axis direction of the display screen, and the picture image has a size in the at least one axis direction which is larger than the predetermined size.

9. The character input method as claimed in claim 6, wherein
the moving step includes moving the picture image in increments based on a size of the key areas.

10. The character input method as claimed in claim 6, wherein
the display screen includes a first display area operable to display a scrolling image, and a second display area not operable to display a scrolling image;
wherein the function executing step includes displaying input characters in the second display area.
